(19) United States
(12) Patent Application Publication
(10) Pub. No.: US 2009/0312037 A1
(43) Pub. Date: Dec. 17, 2009

(54) APPARATUS AND SYSTEM FOR ESTIMATING LOCATION OF TERMINAL

(75) Inventors: Daehyung Jo, Jeollabuk-do (KR); Jeongkeun Lee, Incheon (KR); Jinyoung Han, Seoul (KR); Taekyoung Kwon, Seoul (KR); Tae Il Kim, Seoul (KR); Tae Joon Ha, Gyeonggi-do (KR)

Correspondence Address: MCCORMICK, PAULDING & HUBER LLP, CITY PLACE II, 185 ASYLUM STREET, HARTFORD, CT, 06103, US

(73) Assignees: RADIANT TECHNOLOGIES, INC., Seoul (KR); SEOUL NATIONAL UNIVERSITY INDUSTRY FOUNDATION, Seoul (KR)

(21) Appl. No.: 12/145,645

(22) Filed: Jun. 25, 2008

(30) Foreign Application Priority Data
Jun. 13, 2008 (KR) 10-2008-0055946

(51) Int. Cl. H04Q 7/20

(52) U.S. Cl. 455/456.2

(57) ABSTRACT

A method and an apparatus for estimating a location of a terminal are provided. The method includes: receiving at least one base station signal from each of at least one base station; computing received signal information with respect to the received signal; and estimating the location of the terminal based on signal transmission direction information associated with the base station and the computed received signal information. The present invention can accurately estimate the location of the terminal based on directional information of base station signals.

### CROSS-REFERENCE TO RELATED APPLICATION

This application claims the benefit under 35 U.S.C. § 119(a) of Korean Patent Application No. 10-2008-0055946, filed on Jun. 13, 2008, in the Korean Intellectual Property Office, the disclosure of which is incorporated herein by reference.

### BACKGROUND OF THE INVENTION

1. Field of the Invention

The present invention relates to a method, an apparatus and a system for estimating a location of a terminal, and more particularly, to a method, an apparatus and a system for estimating a location of a terminal based on a base station signal received from a base station of a mobile communication system.

2. Description of Related Art

Location Based Service (LBS) is one of communication services which utilize locations of mobile terminals. The LBS refers to services providing a moving user with various information associated with a user's location via wired/wireless communication in a convenient and prompt manner. The LBS may be used to confirm and trace locations in emergency or disaster situations, and also to promptly provide traffic or regional information, along with various other information associated with leisure or tourist sites. Additionally, a range of application of the LBS extends further to an area of location based mobile commerce such as in regional goods or souvenir shopping, on-the-spot ticketing, and to a domain of logistics managements in freight, vehicle tracking and the others.

Conventional location measuring techniques which are based on a mobile communication network include cell ID which relies on a cell radius, Time Difference of Arrival (TDOA), a Global Positioning System (GPS), and the like.

The cell ID technique which relies on the cell radius is a technique that determines a location of a mobile terminal to be a location of a base station from which a communication service is currently being provided. This technique has an advantage that location measuring can be provided in any spatial area where communication services are offered, however also has a disadvantage of lacking accuracy as a range of a cell covered by a base stations is too broad and thus, impractical. Also, by relying heavily on the cell radius, large errors in measuring a location of a terminal may be generated in places where cell radiuses are broader such as in suburban areas or in shadow areas. Also, strength of signals received from each base station differ from each other, and thus, do not sufficiently satisfying the intention of accuracy. A TDOA technique, which is based on a triangulation technique, utilizes time information of radio wave signal propagation to calculate a distance between a mobile terminal and a base station, and performs the triangulation utilizing a distance from the adjacent base stations. This technique has a disadvantage in that it requires separate apparatuses for terminals and base stations. A GPS technique is another triangulation technique. The GPS technique is based on signals transmitted from satellites, and results in highly accurate locations with insignificant errors. The GPS technique can be used in mobile communication networks by embedding GPS modules in mobile network terminals. In the mobile communication networks, an Assisted GPS (AGPS) technique is used for the purpose of reducing time required for location estimation. The location measuring using such GPS and AGPS techniques is not applicable in indoor or urban environments where signal transmission from satellite is not guaranteed, and also when a GPS or AGPS module is not embedded in mobile terminals.

Besides the above mentioned techniques, there is an angle of arrival (AOA) technique which is based on angle information that signals are received, however obtaining accurate angle information of antennas of base stations and the subsequent maintenance of the obtained angle may cause additional costs for network providers, and there is a problem in that an actual angle of the signal received in the urban environment greatly differs with the angle of antenna.

FIG. 1 is a diagram illustrating a location measuring technique with a conventional art.

A terminal 130 receives base station signals which are distinguishable between each of base stations 110 and 120. The terminal 130 calculates signal strengths for each one of base station signals. The distance from the base stations 110 and 120 to the terminal 130 is inversely proportional to the strengths of received signals. The apparatus for estimating location of terminal can estimate a distance from the base stations 110 and 120 to the terminal 130 based on the signal strengths. The apparatus for estimating location of terminal can estimate a possible location of a terminal 130 to be within circular regions 140 and 150 centering on base stations 110 and 120 considering estimation errors. In the case that base station signals are received from multiple base stations 110 and 120, the apparatus for estimating location of terminal estimates the possible location of a terminal to be within an overlapping section 160 of the assumed regions 140 and 150.

In the conventional art, the apparatus for estimating location of terminal estimates the location of the terminal 130 only with the distance information from the base stations 110 and 120 to the terminal 130. Since the estimated region of the possible location of the terminal 130 is impractically large, a result of estimated location is also inaccurate.

### BRIEF SUMMARY

The objective of the present invention is to accurately measure a location of a terminal based on base station signals received from a base station.

The objective of the present invention is to accurately measure a location of a terminal based on directional information of signal transmission from a base station.

To achieve the above objectives, and to solve the problem with the conventional art, the present invention provides a method for estimating a location of a terminal including: receiving at least one base station signal from each of at least one base station; computing received signal information with respect to the received signal; and estimating the location of the terminal based on signal transmission direction information associated with the base station and the computed received signal information.

In an aspect of the present invention, there is provided an apparatus for estimating a location of a terminal: a base station signal information receiving unit receiving base station signal information of at least one base station signal being transmitted from at least one base station to a terminal; a base station information receiving unit receiving signal transmission direction information of the base station; and a location estimation unit estimating the location of the terminal based on the base station signal information and signal transmission direction information of the base station.

In another aspect of the present invention, there is provided a system for estimating a location of a terminal including: at least one base station device transmitting a base station signal to the terminal; a base station information storage device storing signal transmission direction information of the base station; and a location estimation device further considering the base station signal and the signal transmission direction information of the base station to estimate the location of the terminal.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a method for estimating a location of a terminal according to a conventional art;

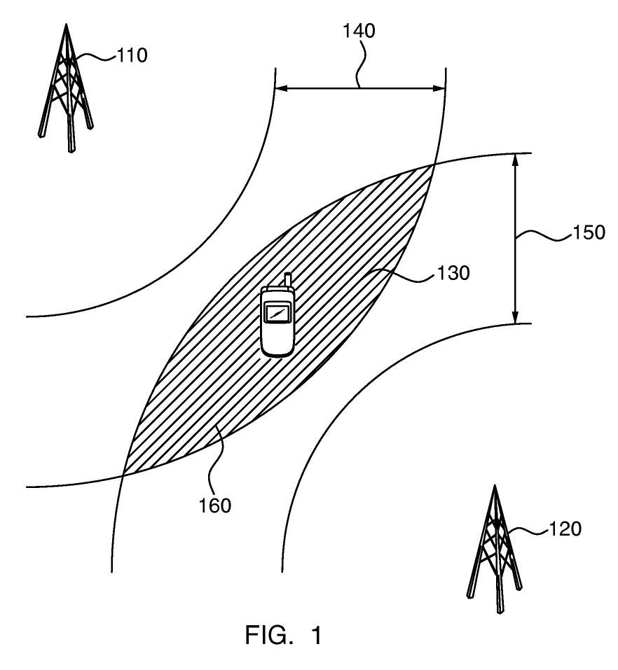

FIG. 2 is a diagram illustrating a configuration of a system for estimating a location of a terminal according to an exemplary embodiment of the present invention;

FIG. 3 is a diagram illustrating an example of directional information of signal transmission used in a method for estimating a location of a terminal according to an exemplary embodiment of the present invention;

FIG. 4 is a diagram illustrating an example that accurately estimates a location of a terminal based on directional information of signal transmission according to an exemplary embodiment of the present invention;

FIG. 5 is a block diagram illustrating a structure of an apparatus for estimating a location of a terminal according to an exemplary embodiment of the present invention;

FIG. 6 is a block diagram illustrating a structure of an apparatus for storing base station information according to an exemplary embodiment of the present invention;

FIG. 7 illustrates a reference table storing the directional information of signal transmissions which are associated with the base stations according to an exemplary embodiment of the present invention;

FIGS. 8A through 8D are graphs illustrating multiple phases of estimating a location of a terminal based on base station signals received from a plurality of base stations, according to an exemplary embodiment of the present invention; and

FIG. 9 is a flowchart illustrating multiple phases of estimating a location of a terminal based on directional information of signal transmission from a base station, according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

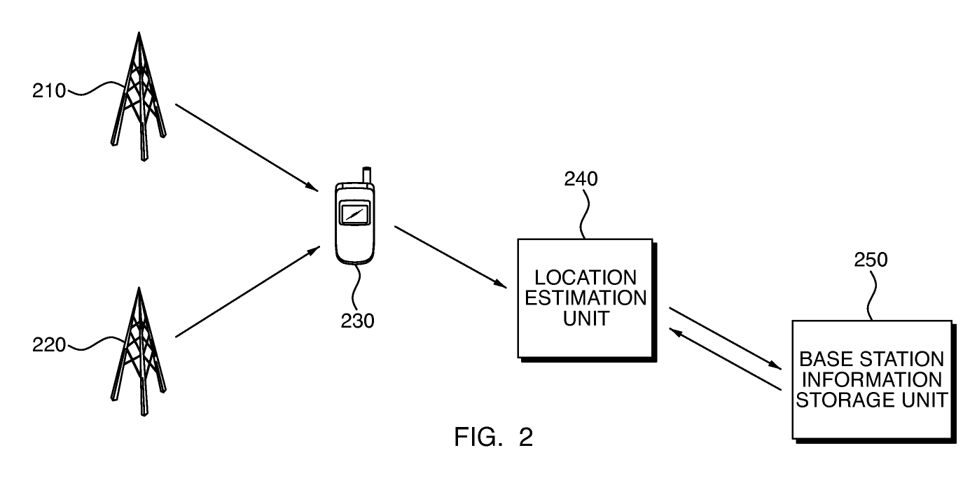

FIG. 2 is a diagram illustrating a configuration of a system for estimating a location of a terminal according to an exemplary embodiment of the present invention. Hereinafter, the configuration of the system for estimating location of terminal will be described in detail by referring to FIG. 2. The configuration of the system for estimating location of terminal includes at least one of base stations 210 and 220, a terminal 230, an apparatus for estimating a location of a terminal 240, and an apparatus for storing base station information 250.

The base stations 210 and 220 transmit base station signals to the terminal 230. In an exemplary embodiment of the present invention, the base station signals can include identifiers used for identifying each of base stations. The terminal 230 receives the base station signals which include the base station IDs, and can identify each of the base stations 210 and 220 with the base station IDs.

In another exemplary embodiment of the present invention, each of the base stations 210 and 220 can be distinguishable by different codes. In an exemplary embodiment of the present invention, each of the base stations transmits orthogonal signals to the terminal 230, and the terminal 230 can identify each of the base stations using the orthogonality of the base station signals.

In another exemplary embodiment of the present invention, each of the base stations 210 and 220 can be identifiable with pseudo noise (PN) codes. Each of the base stations 210 and 220 transmits base station signals which include PN codes with unique starting point, and the terminal 230 compares the starting point of each PN code to identify each of the base stations 210 and 220.

In another exemplary embodiment of the present invention, the terminal 230 receives base station signals from the base stations 210 and 220, and can generate the base station information with respect to the received base station signals. The base station information generated in the terminal 230 can include strength of the received base station signals or a number of received base station signals.

The apparatus for estimating location of terminal 240 estimates the location of the terminal based on directional information of the associated base station signals received, and the received signal information.

In a case when a plurality of base stations 210 and 220 are closely arranged with each other, it is general that there is an overlapping region in the coverage of the base stations 210 and 220. In other words, in a specific region in the coverage of the first base station 210, the terminal 230 can receive base station signals from the first base station 210 along with base station signals from the second base station 220. Consequently, by utilizing the number of base station signals received in the terminal 230, it is possible to obtain more accurate terminal location.

The base station signals from the base stations 210 and 220 undergo path loss in long distance propagations. Therefore, as the distance between the terminal 230 and the base stations 210 and 220 increases, the strength of signals from base stations diminishes. By utilizing the strength of the base station signal received in the terminal 230, it is possible to obtain more accurate terminal location.

The apparatus for storing base station information 250 stores directional information of signals transmission in the each of the base stations 210 and 220. In an exemplary embodiment of the present invention, the directional information of signal transmission can include information of antenna direction in each of base and radiation pattern information of the antenna.

In the case that a directional antenna is installed in a base station, the base station signals transmitted using the antenna are concentrated into a specific direction. In this case, the base station signals can be received in specific directions within the coverage, however cannot be received in other directions. In another case, the base station signals with strong strengths can be received in specific directions within the coverage, however cannot be received in other directions. Consequently, by considering the direction of the antenna installed in base stations or considering the radiation pattern information of the antenna can assist in more accurate estimation of the location of terminal 230.

In an exemplary embodiment of the present invention, the apparatus for storing base station information 250 can store location information for each of the base stations. The apparatus for estimating location of terminal 240 can receive the location information for each of the base station, and estimate the location of the terminal further considering base station information. The signal strength of base station signal or the number of base station signals received in the terminal 230 can be considered for the location estimation of the terminal 230 to obtain the relative location of the terminal 230 from the base stations 210 and 220. That is, it is possible to estimate that the terminal 230 is located from a predetermined certain distance in the predetermined direction from base stations 210 and 220.

When the location information of the base stations 210 and 220 is additionally considered to estimate the location of the terminal 230, it is possible to estimate absolute location of the terminal 230, that is longitude and latitude information about the location of the terminal 230.

The apparatus for estimating location of terminal 240 may be illustrated as being a separate apparatus from the terminal 230, however depending on an exemplary embodiment of the present invention, the apparatus for estimating location of terminal 240 may be a part of the terminal 230 and may be embedded in the terminal 230. In another example of the present invention, the apparatus for estimating location of terminal 240 is a part of mobile communication system, which estimates the location of the terminal 230 based on the information transmitted from the terminal 230, and transmits back the estimated location information via the base stations 210 and 220.

The base stations 210 and 220 in FIG. 2 may be illustrated as being separate base stations, however in another example of the present invention, each of base stations 210 and 220 can also be separate sectors in a same base station.

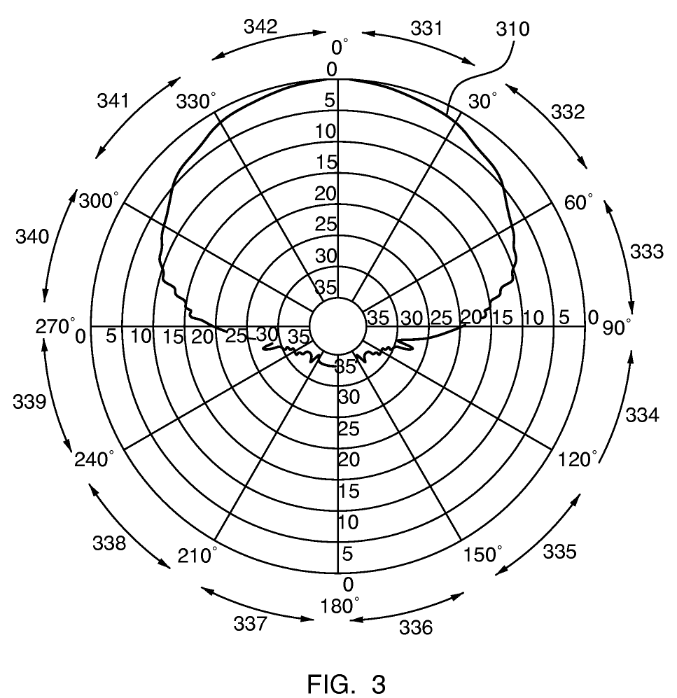

FIG. 3 is a diagram illustrating an example of directional information of signal transmission used in a method for estimating a location of a terminal according to an exemplary embodiment of the present invention. Hereinafter, information of directional information of signal transmission will be described in detail by referring to FIG. 3.

Base stations transmit base station signals over the entire coverage area. In the conventional terminal location estimation technique, base stations can transmit base station signals using an omni-direction antenna which has one identical radiation pattern for all directions. The base station signal is transmitted in all direction with the same strength, therefore the apparatus for estimating location of terminal is not required to consider the directional information of signals transmitted from base stations.

In an example of the present invention, a base station can be divided in a plurality of sectors in the entire coverage, along with directional antenna to transmit base station signals per sectors.

In an exemplary embodiment of the present invention, a base station is divided into three sectors, and each sector is equipped with three directional antenna to transmit base station signals. Each of the directional antenna can transmit a radio wave in the range of −60° to +60° from the direction of the antenna, and cannot transmit in the other ranges. A radiation pattern 310 of direction antenna illustrated in FIG. 3 represents strengths of base station signals transmitted to each of the directions. Even in the case signals for the identical base station are transmitted to the antennas, a strength of a base station signal of 0° may be different from a strength of a base station signal of 60°.

In the radiation pattern 310 of FIG. 3, in the region of −60° to 30° 341, −30° to 0° 342, 0° to 30° 331, 30° to 60° 332, radio waves are transmitted with higher values than predetermined values, however in the region of +60° to −60° 333, 334, 335, 336, 337, 338, 339, and 340, the radiation pattern rapidly diminishes, and antennas are not transmitting signals at all.

The apparatus for estimating location of terminal can estimate the distance from base stations to a terminal by considering the strengths of received signals from a specific base station, and by considering the directional information of signals from related base stations or the number of base station signals received.

In FIG. 3, the coverage of a base station is divided into three sectors, and the radiation pattern of antenna for transmitting base station signals for each of the sectors are illustrated. In an exemplary embodiment of the present invention, a base station coverage can be divided into N numbers of sectors, and a base station can be equipped with N number of antennas with respect to each sector transmitting base station signals. In an exemplary embodiment of the present invention, each sector can be given with different angles. In this case, the radio wave propagation pattern of the first sector may be different from radiation pattern information of the second sector.

In an exemplary embodiment of the present invention, each sector can be overlapped with other sectors. In such case, a single regional point can be included in a plurality of sectors. Also, in this case, the location estimation of a terminal can be performed based on installation direction of directional antenna which transmit base station signals to each of the sectors, and based on radiation patterns of each of the antennal.

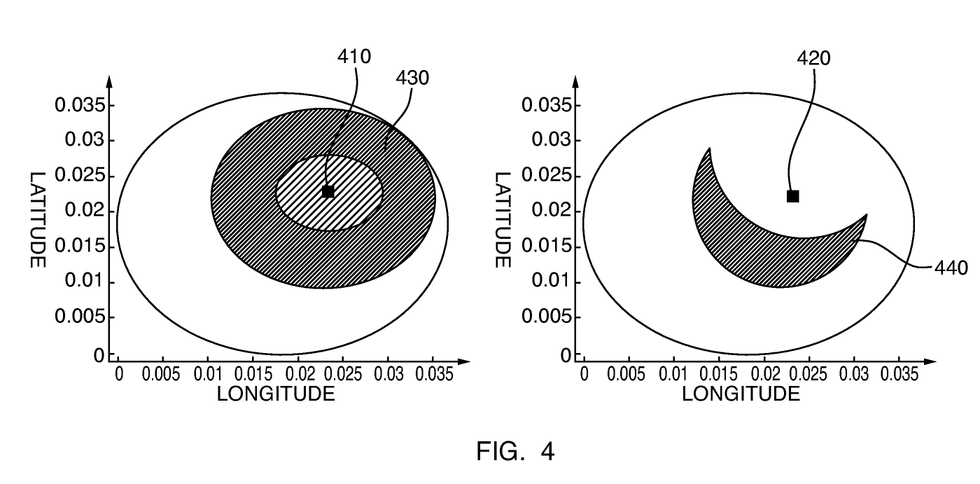

FIG. 4 is a diagram illustrating an example that accurately estimates a location of a terminal based on directional information of signal transmission according to an exemplary embodiment of the present invention.

In the case a base station 410 is transmitting signals with an omni-directional antenna, the apparatus for estimating location of terminal estimates the location of the terminal using base station signals received from the terminal. In the case a base station is transmitting signals using an omni-directional antenna, the strengths of base station signals from base stations may be identical regardless of directions. The apparatus for estimating location of terminal cannot utilize the directional information of signal transmission from base stations. The base station signals transmitted from base stations undergoes path losses due to transmission distances, and decreases in strength. The base station signal strengths received in the terminal is inversely proportional to the distance from a base station to a terminal.

In an exemplary embodiment of the present invention, the apparatus for estimating location of terminal can calculate a probability of a location of a terminal at each point based on the signal strengths of base station signals, received in the terminal. In an exemplary embodiment of the present invention, the probability of the terminal location forms a Gaussian distribution based on the distance from the base stations. A first terminal existence region 430 represents a region with the probability of the terminal existence which is higher than a predetermined threshold value. A probability of the terminal location in the other region is not ‘0’, however it is under the predetermined threshold value. Such threshold value is to distinctly differentiate areas where the probabilities of terminal existence are different, and the threshold value is not a factor which affects the estimation of terminal location.

In the present invention, the apparatus for estimating location of terminal can estimate the location of the terminal based on directional information of signal transmission from base stations. Base stations can transmit signals only in specific directions within the coverage, or base stations can transmit base station signals which can be different in sectors by utilizing antennas corresponding to each sector. In an exemplary embodiment of the present invention, it is possible to transmit first base station signals to a first sector direction, and transmit second base station signals to a second sector direction. A terminal which is located in both sectors can receive base station signals from both sectors, and the apparatus for estimating location of terminal can determine the sectors where a terminal belongs.

A first directional antenna corresponding to a first sector transmits a first base station signal to a first sector direction with signal strength stronger than a first signal strength threshold. Also, the first directional antenna transmits the first base station signal which is below a second threshold to a second sector direction only. The second threshold is generally larger than ‘0’, therefore the first base station signal is also transmitted to a second direction only. A terminal located in the first sector region receives base station signals from the antenna corresponding to the first sector. Also, a terminal can receive base station signals from the antenna corresponding to the second sector. That is, a terminal receives base station signals transmitted to a sector where a terminal is located, and also receives base station signals designed to be transmitted to other sectors.

Regarding the directional antennas, the first threshold is reasonably larger than the second threshold. Comparing signal the strengths of base station signals received in a terminal from each of the base stations, the signal strengths from the first base station signals are largely stronger than the signal strengths from the second base station signals. Consequently, even in the case a terminal has received signals from a plurality of base stations, the terminal location and the directions can be easily estimated by comparing the signal strengths from each of the base station signals.

In the case further consideration of directional information of base station signal transmission is used in a terminal location estimation performed by the apparatus for estimating location of terminal, a probability where a terminal can be located in a specific direction 440 from the base station can be higher than the others.

In an exemplary embodiment of the present invention, the apparatus for estimating location of terminal can multiply the probability of a terminal location from the directional information of base station signals by the probability of a terminal location from the strength of base station signals. The multiplied probability is a more accurate probability since both of signal strength and the directional information of base station signals are considered. Also, using the multiplied probability, it is possible to more accurately estimate the region of a terminal location.

When it is assumed that a second terminal existence region 440 is where the multiplied probability is higher than the predetermined threshold, an area of the second terminal existence region 440 is smaller than a first terminal existence region 430. Consequently, the apparatus for estimating location of terminal can more accurately estimate the location of the terminal based on directional information from base stations transmissions.

In an exemplary embodiment of the present invention, the apparatus for estimating location of terminal can estimate the location of the terminal using signals only with the highest signal strengths among signals received from multiple base stations. In an exemplary embodiment of the present invention, the apparatus for estimating location of terminal can estimate a probability of terminal existence at each point base on the antenna direction of base station with the highest signal strengths, from among the plurality of base station signals received in the terminal.

In an exemplary embodiment of the present invention, the apparatus for estimating location of terminal can estimate the terminal location based on a number of base station signals received in a terminal. A terminal can receive a plurality of base station signals from base stations. However, when considering complex urban propagation environment, in a first region within the base station coverage can receive signals transmitted to three sectors, however in a second region which is in the adjacent to the first region may only receive base station signals transmitted to two sectors or transmitted to one sector. Consequently, the apparatus for estimating location of terminal can consider the number of base station signals to more accurately estimate the location of the terminal.

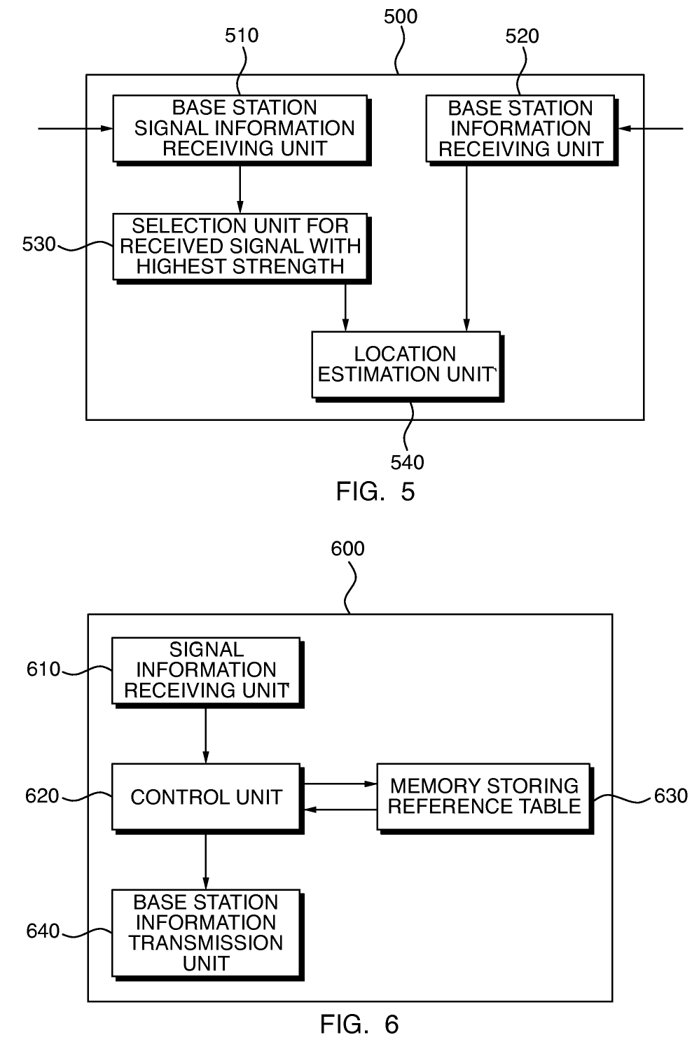

FIG. 5 is a block diagram illustrating a structure of an apparatus for estimating a location of a terminal 500 according to an exemplary embodiment of the present invention. Hereinafter, operations of the apparatus for estimating location of terminal will be described in detail by referring to FIG. 5. The apparatus for estimating location of terminal 500 includes a base the base station signal information receiving unit 510, a base station information receiving unit 520, a highest signal selector 530, and a location estimation unit 540.

The base station signal information receiving unit 510 receives base station signal information for base station signals transmitted from a plurality of base stations to a terminal. At least one base station transmits base station signals to the terminal. In an exemplary embodiment of the present invention, a number of base stations signals received in a terminal can vary depending on the terminal locations. Similarly, signal strengths for base station signals may vary depending on the terminal location. In an exemplary embodiment of the present invention, the base station signal information may include the number of base station signals received in the terminal or the signal strength of base station signals. It is possible to accurately estimate the location nof the terminal by considering both the number of base station signals and the strengths of base station signals.

The base station information receiving unit 520 receives signal directional information of base stations which have transmitted base station signals to the terminal. Base stations transmit base station signals to specific directions using directional antennas. Consequently, it is possible to have a base station signal received in a specific direction within the coverage to be different than a base station signal received in another direction specific direction. In an exemplary embodiment of the present invention, the directional information of signal transmission may include the antenna direction which transmits the base station signals or include radiation pattern information of the transmission antennas.

A highest signal selector 530 selects signals with highest strengths from signals which a terminal has received from the plurality of base stations. In an exemplary embodiment of the present invention, the highest signal selector 530 can select signals with highest strengths based on the strength information of signals from the received base station signals.

The location estimator 540 estimates the location of the terminal based on the base station signal information and the directional information of the signal transmission. In an exemplary embodiment of the present invention, the base station signal information may include the number of signals received in the terminal, and the location estimation unit 540 can estimate the location of the terminal based on the number of base station signals received in the terminal.

In an exemplary embodiment of the present invention, the base station signal information may include the signal strength information of base station signals received in the terminal, and the location estimation unit 540 can estimate the location of the terminal by considering the strength information of the received base station signals.

In an exemplary embodiment of the present invention, the location estimation unit 540 can estimate the location of the terminal only with considering the base station information from a base station with the highest signal strength. In an exemplary embodiment of the present invention, the base station which has transmitted signals with the highest strength is may be a base station which is very close to a physical location of the terminal. Consequently, in most cases, considering only the base station information with the highest signal strength may be sufficiently accurate in location estimation of the terminal. The location estimation unit 540 can estimate the location of the terminal by considering the base station information from a base station with the highest signal strength.

In an exemplary embodiment of the present invention, the location estimation unit 540 can estimate a possible location of a terminal with an antenna direction which has transmitted the base station signals with the highest signal strength.

In an exemplary embodiment of the present invention, the base station information can include geographical information at each point of each of the base stations in coverage, and a probability to receive base station signals transmitted from each of the base stations. In an exemplary embodiment of the present invention, the location estimation unit 540 considers the probability to receive in order to estimate the location of the terminal at each point of base stations within the coverage. In an exemplary embodiment of the present invention, when the probability to receive base station signals is higher in a specific regional point within the coverage, the location estimation unit 540 can assume that the probability that a terminal can be located in the specific point is higher.

In an exemplary embodiment of the present invention, location estimation unit 540 can estimate the location of the terminal based on the number of base station signals received in the terminal, estimate the location of the terminal based on the number of base station signals received in the terminal according to directional information of a sector which transmitted the signals with the highest strength, or estimate the location of the terminal based on the number of base station signals received in the terminal according to strengths of signals from each of the base stations. In an exemplary embodiment of the present invention, location estimation unit 540 can estimate the probability of existence of the terminal at each point of the coverage based on the number of the base signal signals received in the terminal, the directional information of signal transmission from the sector with the signal with the highest strength signal strength, and the signal strength of base station signals.

In an exemplary embodiment of the present invention, the location estimation unit 540 can estimate the probability of the terminal existence at each point within the coverage based on the number of base station signals received in the terminal, and estimate the probability of terminal existence at each point within the coverage based on the directional information of signal transmission from a sector with the highest signal strengths. Also, the location estimation unit 540 can estimate the probability of the terminal existence at each point within the coverage based on signal strengths of each of the base station signals.

In an exemplary embodiment of the present invention, the location estimation unit 540 can estimate the probability of terminal existence at each point by multiplying the estimated plurality of probabilities.

In an exemplary embodiment of the present invention, the location estimation unit 540 can estimate the location of the terminal based on a plurality of multiple base station signals. In an exemplary embodiment of the present invention, the location estimation unit 540 can estimate regions where the terminal is likely to be located based on the multiple base station signals.

In an exemplary embodiment of the present invention, the location estimation unit 540 can determine an overlapped area from the calculated regions from each of the base station signals for the location of the terminal to be the location of the terminal.

In another example of the present invention, the location estimation unit 540 can calculate the probability of the terminal existence for a specific point by multiplying the calculated probabilities from each of the base station signals.

In an exemplary embodiment of the present invention, the base station information may include the location information of each of the base stations. In an exemplary embodiment of the present invention, the location information of each of the base station may include geographical information, specifically longitude and latitude information. In the present invention, the location estimation unit 540 can calculate the latitude and longitude information of the terminal based on latitude and longitude information of base stations.

In an exemplary embodiment of the present invention, the information storage apparatus can store the strength of base station signals, measured in multiple points within the coverage of a base station, in a form of database. In an exemplary embodiment of the present invention, the strength of the received signals can be received in a form of a Gaussian distribution.

In an exemplary embodiment of the present invention, the information storage apparatus can store the probability for the terminal to exist at each position within the coverage of the base station in a pair of an average value and a standard deviation, the probability for the terminal to exist at each position within the coverage of the base station according to the number of base station signals received in the terminal at each estimation point, received directions of the base station signals, and a strength of the received base station signals

In an exemplary embodiment of the present invention, the information storage apparatus can receive signal information by a request of the apparatus for estimating location of terminal 500. In an exemplary embodiment of the present invention, the information received by the information storage apparatus can include the number of signals received, the signal strength of base station signals and the like.

In an exemplary embodiment of the present invention, the information storage apparatus can transmit the base station information to the apparatus for estimating location of terminal. In an exemplary embodiment of the present invention, the information transmitted by the information storage apparatus can include a probability distribution per each point of a terminal coverage. In an exemplary embodiment of the present invention, the probability distribution information can include average and standard deviation for the terminal to be in existence for a specific point within the coverage.

In an exemplary embodiment of the present invention the apparatus for estimating location of terminal can estimate the location of the terminal based on the received probability distribution information.

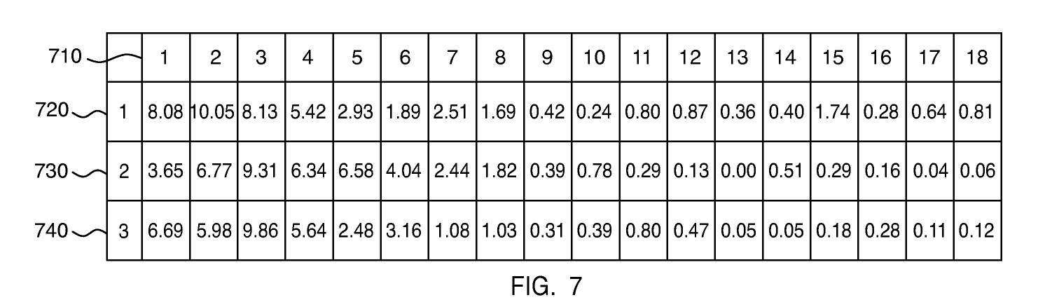

FIG. 6 is a block diagram illustrating a structure of an apparatus for storing base station information according to an exemplary embodiment of the present invention, the apparatus for storing base station information storing a reference table which includes a combination of directional information of signal transmissions of a base station and information of a distance from a base station to a terminal. Hereinafter, operations of the apparatus for storing base station information will be described in detail by referring to FIG. 6. The apparatus for storing base station information 600 includes a signal information receiving unit 610, a control unit 620, memory storing a reference table, and a base station information transmission unit 640.

The signal information receiving unit 610 receives base station information from the apparatus for estimating location of terminal. In an exemplary embodiment of the present invention, the base station signal information received by the signal information receiving unit 610 can include an identifier for base station. In an exemplary embodiment of the present invention, the base station including the identifier can be identified with a base station which transmitted base station signals to the terminal.

The memory storing reference table 630 stores a reference table associated with directional information of base station signals. In an exemplary embodiment of the present invention, the memory storing reference table 630 can be either a memory or a hard disk. In an exemplary embodiment of the present invention, the reference table can store strength information received from signals received from different directions to the base station within the coverage.

In another application example of the present invention, the reference table can include a probability of a terminal being in a specific point within the coverage according to a signal strength of the base station signals received by a terminal or a number of base station signals received by a terminal.

The control unit 620 refers to the reference table based on the base station signal information. In an exemplary embodiment of the present invention, the control unit 620 can refer to the probability of the terminal at each point of coverage within the reference table.

In the base station information transmitter 640, the directional information of base station signal being referred in the reference table by controller 620 is transmitted to an apparatus for estimating location of terminal. In an exemplary embodiment of the present invention, the apparatus for estimating location of terminal can accurately estimate the location of the terminal based on the directional information of base station signals.

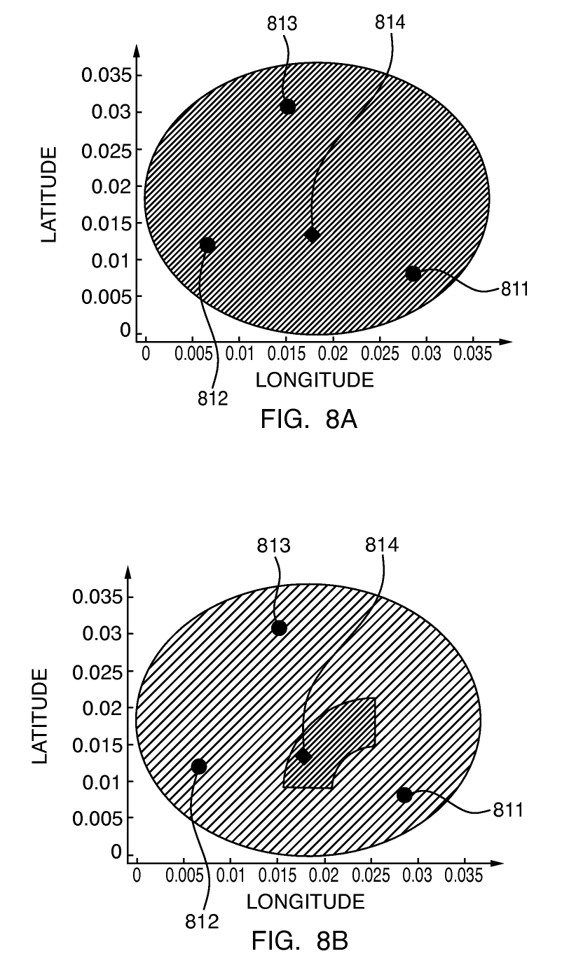

FIG. 7 is a table illustrating the reference table storing the directional information of signal transmissions which are associated with the base stations. Hereinafter, the reference table according to the present invention will be described in detail by referring to FIG. 7.

A first row 710 displayed in FIG. 7 refers to each direction within a base station. In FIG. 7, a single row in the first row 710 represents a direction of 10 degrees from a center of the base station. This means that a first block in the first row refers to 10 degrees to the right from the center of base station antenna, and a second block in the first row represents the angle between 10 degrees to the right of 10 degrees to the right.

FIG. 7 illustrates an example of a base station antenna with a symmetrical characteristic. Specifically, information regarding a left side has been omitted under assumption that the information regarding left side is identical to that of a right side. In another example of the present invention, a radiation pattern of the antenna can be asymmetrical. In such case, a reference table with additional information of the left side can be used.

A second row 720 in the reference table of FIG. 7 represents a probability of a terminal in each of the directions when a number of base station signals received by a terminal is one. This means that a second block of the second row 720 represents that a probability of a terminal location in the angle of 10 degrees to the right from the center of the base station antenna is 8.08 percent. Similarly, the second row of the second row 720 represents that a probability of a terminal location in the angle of 20 degrees to the right from the angle of 10 degrees to the right is 10.05 percent.

A third row 730 in the reference table of FIG. 7 represents a probability of a terminal in each of the directions when a number of base station signals received by a terminal is two. This means that a first block in the third row 730 represents that a probability of a terminal location in the angle of 10 degrees to the right from the center of the base station antenna is 3.65 percent when there are two base station signals received by a terminal. When a terminal has received a plurality of base station signals, the apparatus for storing base station information can refer to the reference table based on the antenna which has transmitted signals with the highest strength.

Similarly, a second block in the third row 730 represents that a probability of a terminal location in the angle of 20 degrees to the right from the angle of 10 degrees to the right is 6.77 percent when there are two base station signals received by a terminal.

As described above, a fourth row 740 represents a probability of a terminal in each of the directions when the number of based signals received by a terminal is three.

In FIG. 7, in the example reference table, 10 degrees intervals from the center of base station comprising each row are included, however, in another exemplary embodiment of the present invention, it is possible to include angle intervals less than 10 degrees or more than 10 degrees.

Also, in another exemplary embodiment of the present invention, each of the blocks of the reference table can include information for different angles. In the case the first block has information for the 10 degrees interval, the second block may include information for the 20 degrees interval.

In an exemplary embodiment of the present invention, the reference table can be configured by measuring base station signals at each point within the coverage of a base station. In an exemplary embodiment of the present invention, the reference table can be constructed by equipping receiving equipment onto a vehicle or other mode of transportation for measuring base station signals, and by traveling via a plurality of points within coverage of the base station. In an exemplary embodiment of the present invention, it is possible to use GPS signals to generate geographical information for the multiple points within the coverage of a base station. In an exemplary embodiment of the present invention, the reference table can store the geographical information of each of the measuring points and the probability to receive base station signals for each of the base measuring points, or the probability of the terminal existence in each of the base measuring points.

In FIG. 7, although an example of the reference table in which the probability of the terminal existence varies depending on the number of base station signals received by a terminal and the combination of directions within the coverage, in another example of the present invention, it is possible to use a reference table in which the probability of the terminal existence varies depending on the signal strength of base station signals received by a terminal and the combination of directions within the coverage.

In FIG. 7, the reference table which includes the probability of the terminal existence in the specific direction from the center of a base station, however in another example of the present invention, a reference table which includes the probability of the terminal existence in a specific location within a coverage can be used for location estimation of the terminal.

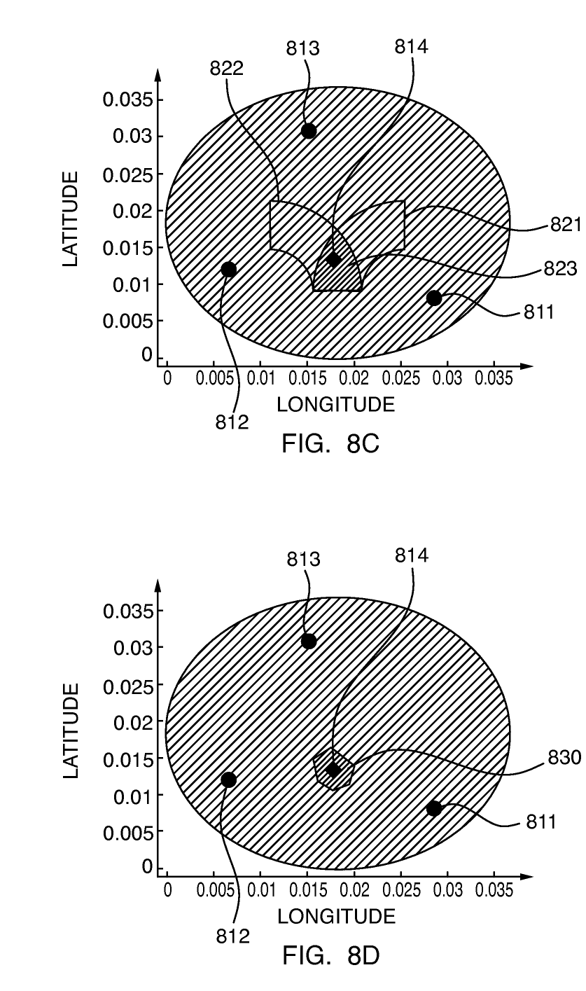

FIGS. 8A through 8D are graphs illustrating an example of the present invention in multiple phases of estimating a location of a terminal based on base station signals received from a plurality of base stations.

FIG. 8A illustrated a graphs in which a terminal 814 receives base station signals from a plurality of base stations 811, 812, and 813. The terminal 814 receives the base station signals from multiple base stations 811, 812, and 813, and the apparatus for estimating location of terminal can estimate a location of the terminal based on the base station signals received in the terminal. In an exemplary embodiment of the present invention, the apparatus for estimating location of terminal can estimate the location of the terminal based on directional information for the base station signals.

FIG. 8B illustrates a graph in which a location of a terminal is estimated under considerations that a first base station signal from the first base station 811 is received by a terminal 814. The apparatus for estimating location of terminal considers the first base station signal of a first base station 811 received in the terminal 814 to identify the first base station 811 and receives the base station information of the identified first base station 811 from the apparatus for storing base station information.

In an exemplary embodiment of the present invention, the base station information can include directional information of signals from the first base station 811. In an exemplary embodiment of the present invention, the directional information of signals from the first base station 811 can include the directional information of antenna installation in base station or radiation pattern information of the base station. The apparatus for estimating location of terminal considers the directional information of signal transmission from the first base station, in order to estimate the location of the terminal 814. Therefore, the location of the terminal 814 can be estimated to be in a crescent shaped region 821 rather than a circular region.

In an exemplary embodiment of the present invention, the apparatus for estimating location of terminal can calculate a first probability of the location of the terminal at each point within the coverage of the first base station 811 based on the first base station signals from the first base station 811.

In an exemplary embodiment of the present invention, the apparatus for estimating location of terminal can select signals with the highest strength from signals received by the terminal 814 from a plurality of sectors of a same base station, and identifies the base station which transmitted to the base station information storage using the identification of the sector which corresponds with the highest strength signals. The apparatus for storing base station information can transmit the directional information of a sector antenna which transmitted the signals with the highest strength to the apparatus for estimating location of terminal. In an exemplary embodiment of the present invention, the directional information of the base station can include a probability of a terminal location for the directions within the coverage of a base station. In an exemplary embodiment of the present invention, the probability of a terminal location can be high in a direction where a base station is transmitting base station signals with high strength, and low in a direction where a base station is transmitting base station signals with low strength. The apparatus for estimating location of terminal can calculate probabilities of a terminal location in the changes of directions from the center of the base stations.

FIG. 8C illustrates terminal location estimation additionally considering the second base station signals received in the terminal 814 from a second base station 812. In an exemplary embodiment of the present invention, the apparatus for estimating location of terminal can calculate a second probability of the terminal at each point based on a second base station signal from the second base station 812.

In an exemplary embodiment of the present invention, in the case a probability is higher than a predetermined threshold between the first probability and the second probability, the apparatus for estimating location of terminal can estimate the corresponding point 821 and 822 as the location of the terminal.

In another example of the present invention, the apparatus for estimating location of terminal can estimate the location of the terminal only when both the first probability and the second probability for a specific point are higher than the predetermined threshold. In such case, as the terminal 814 receives more base station signals, the location of the terminal estimated by the apparatus for estimating location of terminal becomes more accurate.

In another application example of the present invention, the apparatus for estimating location of terminal can calculate the probability of a terminal location for a specific point by multiplying the first probability with the second probability. The multiplied probability is reflected with both of the first base station signal and the second base station signals. The apparatus for estimating location of terminal can estimate the location of the terminal more accurately with the multiplied probability.

FIG. 8D illustrates a diagram of a terminal location further considering third base station signals received in the terminal 814 from a third base station 813. The terminal 814 receives the third base station signals from the third base station 813, and the apparatus for estimating location of terminal considers the third base station signals to calculate a third probability of a terminal location at each point. The apparatus for estimating location of terminal considers all of the first probability, the second probability, and the third probability to more accurately estimate the location of the terminal. When the accuracy in location of a terminal increases, an area for the terminal location 830 existing becomes smaller.

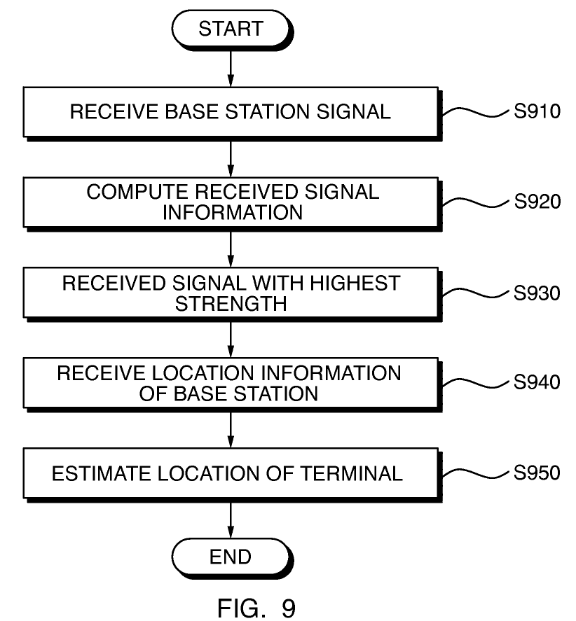

FIG. 9 is a flowchart illustrating an example of the present invention in multiple phases of estimating a location of a terminal based on directional information of signal transmission from a base station.

In operation S910, a terminal receives base station signals from a plurality of base stations. In an exemplary embodiment of the present invention, a base station can divide a coverage being allocated to each base station into a plurality of sectors, and can transmit base station signals to the plurality of sectors transmit. The terminal can receive at least one of the base station signals being transmitted to each of the plurality of sectors. As an example, when a terminal has received three base station signals, the terminal can receive a first base station signal transmitted to a first sector in the first base station, a second base station signal transmitted to a second sector in the first base station, and a third base station signal transmitted to the second base station.

In operation S920, the terminal can calculate signal strengths for at least one of the base station signals individually. The base station signals transmitted to each of the sectors from the base station undergo path losses during the process of being transmitted to the terminal, and the signal strength is reduced during the process. The path loss undergone by the base station signals or the decrease of the signal strengths is inversely proportional to a distance between the terminal and the base station. In the case a terminal is receiving multiple base station signals, the signal strength of the received base station signals may all differ from each other.

In operation S930, the apparatus for estimating location of terminal can select signals with a highest strength among the at least one base station signals, by the calculations of the terminal.

In operation S940, the apparatus for estimating location of terminal receives directional information of signal transmissions which are associated with the base station base on the information storage apparatus. The base station can divide the coverage allocated each sector into the plurality of sectors, and transmit unique base station signals to each sector. Since each of the base station signals are required to be transmit to a corresponding specific sector, the base station can use directional antennas to transmit base station information. As shown in FIG. 3, the directional antennas provide more benefits to a specific direction and less to other directions. Consequently, even in the case where the signal strengths measured in different positions of a base station are different, a distance from the base station to a measuring point may differ from each other. The apparatus for estimating location of terminal can estimate the location of the terminal based on base station signal received in the terminal, along with the directional information of the associated base station.

In operation S950, the apparatus for estimating location of terminal receives the location information for base stations. In an exemplary embodiment of the present invention, the location information of base station received in the apparatus for estimating location of terminal can include longitude or latitude information of each base station.

In operation S960, the apparatus for estimating location of terminal can estimate the location of the terminal based on the directional information of signals received from base station storage apparatus along with the strength of the base station signals received in the terminal.

In the case where the coverage of the base station can be divided into the plurality of sectors and the directional antennas are transmitting identifiable base station signals to each of the sectors, the apparatus for estimating location of terminal can estimate the location of the terminal further considering the directional information of base station. In an exemplary embodiment of the present invention, the directional information of the base station can include directional information of antenna installation in the base station or radiation pattern information of directional antenna.

In the case base stations use directional antennas for transmitting of base station signals, the strength of the signals received in the terminal may vary due to the direction of the terminal with respect to the base station. The apparatus for estimating location of terminal can estimate the location of the terminal based on the directional information of the base station signals.

According to an exemplary embodiment of the present invention, the apparatus for estimating location of terminal can estimate a location of a terminal based on a number of signals received in the terminal, the directional information of a sector which received a signal with a highest strength, or signal strengths of the base station signals. According to an exemplary embodiment of the present invention, the apparatus for estimating location of terminal can calculate a probability for a location of a terminal based on a number of signals received in the terminal, directional information of a sector which received a signal with a highest strength.

According to an exemplary embodiment of the present invention, the apparatus for estimating location of terminal can calculate a probability of terminal existence at each point within a coverage based on a number of base station signals received in the terminal, and also calculate the probability of terminal existence at each point within the coverage based on directional information of the sector which received a signal with a highest strength. Also, the apparatus for estimating location of terminal can calculate the probability of terminal existence at each point in the coverage based on the signal strengths of each of the base station signals.

According to an exemplary embodiment of the present invention, the apparatus for estimating location of terminal can calculate a probability of terminal existence at each point by multiplying plurality of obtained probabilities.

According to an exemplary embodiment of the present invention, a probability of terminal existence at each point within a coverage of each base station can be calculated in operation S960.

According to an exemplary embodiment of the present invention, directional information of signals transmission may be information of signal strength of base station signals which is measured at each of a plurality of points within a coverage of a base station, the base stations signals being transmitted from the base station. The apparatus for estimating location of terminal in an exemplary embodiment of the present invention can calculate a probability of terminal existence at each point by comparing the base station signal strengths measured by a terminal, with base station signal strength measured at each point. In an exemplary embodiment of the present invention, the apparatus for estimating location of terminal can assume the location of the terminal to be the point with a highest probability of terminal existence.

According to an exemplary embodiment of the present invention, in operation S960, a probability calculated for each point is compared with a predetermined threshold, and a point with higher probability than the predetermined threshold can be estimated to be a location of a terminal.

According to an exemplary embodiment of the present invention, in operation S960, an area which is formed in a plurality of points whose probability is higher than a predetermined threshold can be calculated to be an area of a location of a terminal. Otherwise, in operation S960, a center of such area can be calculated to be the location of the terminal, and error deviations can be calculated by considering the area of the location of the terminal.

The method for estimating a location of a terminal according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for estimating a location of a terminal, comprising;
receiving at least one base station signal from each of at least one base station;
computing received signal information with respect to the received signal; and
estimating the location of the terminal based on signal transmission direction information associated with the base station and the computed received signal information.

2. The method of claim 1, wherein the received signal information comprises received signal strength of the received base station signal or a number of base station signals.

3. The method of claim 1, wherein the signal transmission direction information comprises an antenna direction of the base stations or radiation pattern information of the antenna.

4. The method of claim 2, further comprising:
selecting a received signal with the highest strength based on the computed received signal strength,
wherein the estimating of the location of the terminal further considers the selected received signal with the highest strength to estimate the location of the terminal.

5. The method of claim 1, further comprising:
receiving location information of each of the at least one base station,
wherein the estimating of the location of the terminal further considers the location of the base station to estimated the location of the terminal.

6. The method of claim 1, wherein the estimating of the location of the terminal computes a probability that the terminal is located at each point within coverage of the base station.

7. A computer-readable storage medium storing a program for implementing the method of claim 1.

8. An apparatus for estimating a location of a terminal, comprising:
a base station signal information receiving unit receiving base station signal information of at least one base station signal being transmitted from at least one base station to a terminal;
a base station information receiving unit receiving signal transmission direction information of the base station; and
a location estimation unit estimating the location of the terminal based on the base station signal information and signal transmission direction information of the base station.

9. The apparatus of claim 8, wherein the base station signal information comprises received signal strength of the received base station signal or a number of base station signals.

10. The apparatus of claim 8, wherein the signal direction information comprises an antenna direction of the base stations or radiation pattern information of the antenna.

11. The apparatus of claim 8, wherein the location estimation unit further considers the number of received signals to estimate the location of the terminal.

12. The apparatus of claim 8, further comprising:
a received signal with the highest strength selection unit selecting a received signal with the highest strength, from among the base station signal, based on the received signal strength,
wherein the base station information receiving unit receives signal transmission direction information associated with the received signal with the highest strength, and the location estimation unit further considers received signal strength of the received signal with the highest strength and signal transmission direction information associated with the received signal with the highest strength.

13. The apparatus of claim 8, wherein the base station information comprises geometrical information at each point within coverage of the base station and a probability that the each point receives the base station signal.

14. The apparatus of claim 8, wherein the base station information comprises location information of the base station, and the location estimation unit further considers the location information of the base station to estimate the location of the terminal.

15. The apparatus of claim 8, wherein the location estimation unit computes a probability that the terminal is located at each point within coverage of the base station.

16. A system for estimating a location of a terminal, comprising:
at least one base station device transmitting a base station signal to the terminal;
a base station information storage device storing signal transmission direction information of the base station; and
a location estimation device further considering the base station signal and the signal transmission direction information of the base station to estimate the location of the terminal.

17. The system of claim 16, wherein the signal transmission direction information comprises an antenna direction of the base stations or radiation pattern information of the antenna.

18. The system of claim 16, wherein the terminal selects a received signal with the highest strength based on received signal strength of the base station signal, and the location estimation device further considers the signal transmission direction information of the base station which corresponds to the selected received signal with the highest strength to estimate the location of the terminal.

19. The system of claim 16, wherein the location estimation device estimates the location of the terminal based on a number of base station signals.

20. The system of claim 16, wherein the signal transmission direction information comprises geometrical information at each point within coverage of the base station and a probability that the each point receives the base station signal.

21. The system of claim 20, wherein the geometrical information at each point is measured utilizing a global positioning system (GPS) signal.
